(19) United States
(12) Patent Application Publication
(10) Pub. No.: US 2025/0121514 A1
(43) Pub. Date: Apr. 17, 2025

(54) SIX-AXIS ARTICULATED ROBOT

(71) Applicant: Fanuc Corporation, Minamitsuru-gun, Yamanashi (JP)

(72) Inventor: Hidetoshi Uematsu, Minamitsuru-gun, Yamanashi (JP)

(73) Assignee: Fanuc Corporation, Minamitsuru-gun, Yamanashi (JP)

(21) Appl. No.: 18/716,204

(22) PCT Filed: Dec. 13, 2021
(86) PCT No.: PCT/JP2021/045892

§ 371 Date: Jun. 4, 2024

(51) Int. Cl. B25J 19/00; B25J 9/00; B25J 9/16; B25J 17/02

(52) U.S. Cl. CPC B25J 19/0025; B25J 9/0009; B25J 9/1679; B25J 17/0283

(57) ABSTRACT

A six-axis articulated robot includes six motors for driving six axes, respectively, of the 6-axis articulated robot; and a motor driving device having one or more printed circuit boards on which a circuit for driving three or more of the six motors is mounted, the motor driving device being disposed in, in a housing constituting the six-axis articulated robot and as viewed from the base side of the six-axis articulated robot, at least one of the inside of a first extending portion between the motor for driving a second axis and the motor for driving a third axis, and the inside of a second extending portion between the motor for driving the third axis and the motor for driving a fourth axis.

### CROSS REFERENCE TO RELATED APPLICATIONS

This is the U.S. National Phase application of PCT/JP2021/045892 filed Dec. 13, 2021, the disclosure of this application being incorporated herein by reference in its entirety for all purposes.

### FIELD OF THE INVENTION

The present invention relates to a six-axis articulated robot.

### BACKGROUND OF THE INVENTION

A robot having a robot housing including therein a motor driver supplying electric power to a motor driving a joint in the robot is known (such as PTL 1). Such a motor driver generally includes a control circuit controlling the position, the speed, the torque, etc. of a motor, and an inverter circuit generating an alternating-current power signal from direct current.

With regard to an assembly robot, PTL 2 describes that “a first rotating arm 26 is provided with controllers 34 and 35 energizing and controlling the first rotation servo motor 32 and the second rotation servo motor, respectively” (paragraph 0014).

With regard to a configuration of a robot, PTL 3 describes that “according to the first embodiment, the sensor units S1 to S6 and the circuit boards 21 to 34 are connected by wirings 141 to 146. Then, the sensor units S1 to S6 and the circuit boards 31 to 34 are placed inside the robot body 150 in such a way that the supporting wires 141 to 146 do not pass through the joints J1, J4, and J6 being torsional joints” (paragraph 0025).

With regard to a configuration of a robot, PTL 4 describes that “the first motor M1 includes therein a resolver R1 detecting an absolute position being a rotation angle of an output axis in the first motor M1. The resolver R1 is connected to a drive circuit board 25 placed inside the base 11 and is driven by drive power supply output by the drive circuit board 25 (paragraph 0023).

### Citation List

### Patent Literature

PTL 1 Japanese Unexamined Patent Publication (Kokai) No. 2020-25999 A
PTL 2 Japanese Unexamined Patent Publication (Kokai) No. H06-320475 A
PTL 3 Japanese Unexamined Patent Publication (Kokai) No. 2019-089143 A
PTL 4 Japanese Unexamined Patent Publication (Kokai) No. 2012-218136 A

### SUMMARY OF THE INVENTION

PTL 1 describes a robot configuration in which a circular control board and a circular drive board are placed behind an actuator including a motor and a reduction gear in such a way as to face the actuator. However, such a robot configuration in which the control board etc. are circularly formed and are placed in such a way as to face the actuator restricts the area of a printed circuit board for a motor driver. A robot configuration that may secure a large area of a printed circuit board for a motor driver is desired.

An embodiment of the present disclosure is a six-axis articulated robot including: six motors for respectively driving six axes in the six-axis articulated robot; and a motor driver including one or more printed circuit boards provided with a circuit for driving three or more motors out of the six motors, the motor driver being placed, in a housing constituting the six-axis articulated robot, in at least one of an inside of a first extending part between a motor driving a second axis and a motor driving a third axis, and an inside of a second extending part between a motor driving the third axis and a motor driving a fourth axis, viewed from a base side of the six-axis articulated robot.

Another embodiment of the present disclosure is a six-axis articulated robot including: six motors for respectively driving six axes in the six-axis articulated robot; and at least one motor driver including one or more printed circuit boards provided with a circuit for driving three or more motors out of the six motors, the at least one motor driver being placed, in a housing constituting the six-axis articulated robot, in at least one of an inside of a first extending part between a motor driving a second axis and a motor driving a third axis, and an inside of a second extending part between a motor driving a fourth axis and a motor driving a fifth axis, viewed from a base side of the six-axis articulated robot.

The aforementioned configurations enable securement of a large area for a printed circuit board provided with a circuit for driving a motor for a joint axis in a six-axis articulated robot.

The objects, the features, and the advantages of the present invention, and other objects, features, and advantages will become more apparent from the detailed description of typical embodiments of the present invention illustrated in accompanying drawings.

### BRIEF DESCRIPTION OF DRAWINGS

FIG. 1 is a perspective view illustrating an external configuration of a robot according to the present embodiment.

FIG. 2 is a diagram illustrating a configuration example of a control system for controlling the robot.

FIG. 3 is a diagram illustrating a circuit configuration example of a motor driver including a control circuit and a drive circuit.

FIG. 4 is a diagram illustrating a first example of a configuration of the robot.

FIG. 5 is a diagram illustrating a second example of the configuration of the robot.

FIG. 6A is a perspective view of a motor driver including a printed circuit board provided with a control circuit.

FIG. 6B is a diagram including a top view, a side view, a bottom view, and a front view of the motor driver in FIG. 6A.

FIG. 6C is a cross-sectional perspective view of the motor driver along a line A-A illustrated in FIG. 6B.

FIG. 7A is a perspective view of a motor driver including a printed circuit board provided with a control circuit.

FIG. 7B is a diagram including a top view, a side view, a bottom view, and a front view of the motor driver in FIG. 7A.

FIG. 7C is a cross-sectional perspective view of the motor driver along a line B-B illustrated in FIG. 7B.

FIG. 8 is a diagram illustrating a state of fixing a motor driver to an internal space of a J2 arm as a cross-sectional view.

FIG. 9 is a perspective view of the state of fixing the motor driver to the internal space of the J2 arm.

FIG. 10 is a diagram illustrating a configuration example of dissipating heat generated in the printed circuit board to a mounting component side through a heat transfer component in the motor driver.

FIG. 11 is a diagram illustrating a configuration example of mounting two printed circuit boards on the motor driver.

FIG. 12 is a diagram illustrating a third example of the configuration of the robot.

FIG. 13 is a diagram illustrating a fourth example of the configuration of the robot.

### DETAILED DESCRIPTION OF EMBODIMENTS OF THE INVENTION

Next, an embodiment of the present disclosure will be described with reference to drawings. In the referenced drawings, similar components or functional parts are given similar reference signs. For ease of understanding, the drawings use different scales as appropriate. Further, configurations illustrated in the drawings are examples for implementing the present invention, and the present invention is not limited to the illustrated configurations.

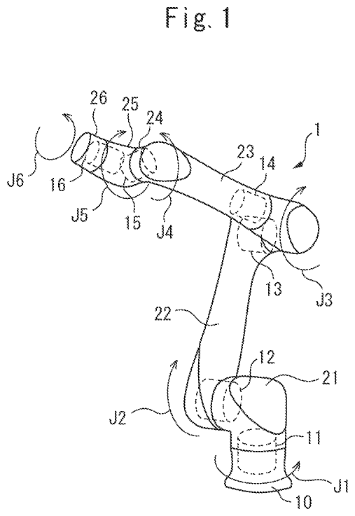

FIG. 1 is a perspective view illustrating an external configuration of a robot 1 according to the present embodiment. FIG. 1 also illustrates six actuators 11 to 16 placed in a housing constituting arms of the robot 1. As illustrated in FIG. 1, the robot 1 is a six-axis articulated robot including a housing with a substantially circular section and including six joint axes driven by the six actuators 11 to 16 placed between a base 10 fixed to an installation surface and an end effector mounting part at the tip. Each of the actuators 11 to 16 includes a motor and a reduction gear. The joint axes are referred to as a J1 axis, a J2 axis, a J3 axis, a J4 axis, a J5 axis, and a J6 axis in ascending order of distance from the base side, respectively. The robot 1 includes the actuator 11 driving the J1 axis, the actuator 12 driving the J2 axis, the actuator 13 driving the J3 axis, the actuator 14 driving the J4 axis, the actuator 15 driving the J5 axis, and the actuator 16 driving the J6 axis in ascending order of distance from the base side, respectively. FIG. 1 indicates the directions of rotation of the axes by the actuators 11 to 16 by arrows J1 to J6, respectively.

The robot 1 includes the base 10 being a foundation supporting the entire robot 1, a J1 arm 21 driven by the actuator 11 in such a way as to rotate around the J1 axis in the vertical direction, a J2 arm 22 driven by the actuator 12 in such a way as to rotate around the J2 axis extending in the horizontal direction, a J3 arm 23 driven by the actuator 13 in such a way as to rotate around the J3 axis, a J4 arm 24 driven by the actuator 14 in such a way as to rotate around the J4 axis, a J5 arm 25 driven by the actuator 15 in such a way as to rotate around the J5 axis, and a J6 arm 26 as a wrist driven by the actuator 16 in such a way as to rotate around the J6 axis.

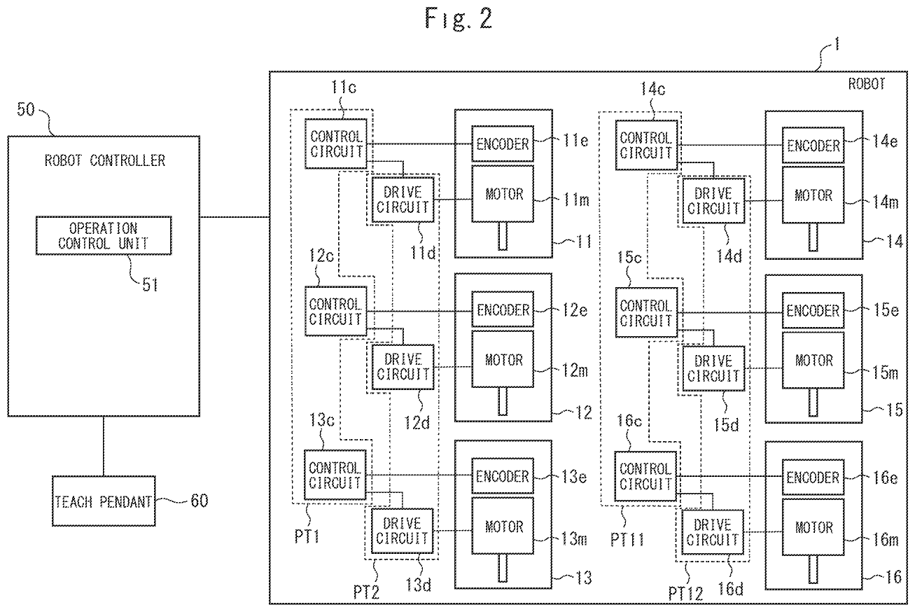

FIG. 2 is a diagram illustrating a configuration example of a control system for controlling the robot 1. As illustrated in FIG. 2, the control system includes the robot 1, a robot controller 50 controlling the robot 1, and a teach pendant 60 connected to the robot controller 50. The teach pendant 60 is used for teaching the operation to the robot 1. The robot controller 50 controls the operation of the robot 1 in accordance with a command from the teach pendant 60 or an operation program. The robot 1 includes the six actuators 11 to 16, and control circuits 11c to 16c and drive circuits 11d to 16d for driving and controlling the actuators.

The actuator 11 includes a motor 11m and an encoder 11e outputting the rotation position of the motor 11m. Similarly, the actuator 12 includes a motor 12m and an encoder 12e outputting the rotation position of the motor 12m, the actuator 13 includes a motor 13m and an encoder 13e outputting the rotation position of the motor 13m, the actuator 14 includes a motor 14m and an encoder 14e outputting the rotation position of the motor 14m, the actuator 15 includes a motor 15m and an encoder 15e outputting the rotation position of the motor 15m, and the actuator 16 includes a motor 16m and an encoder 16e outputting the rotation position of the motor 16m. A motor specified to have a higher load drive capability and a larger size is generally used as a motor located closer to the base side.

The control circuit 11c and the drive circuit 11d for controlling and driving the actuator 11, the control circuit 12c and the drive circuit 12d for controlling and driving the actuator 12, the control circuit 13c and the drive circuit 13d for controlling and driving the actuator 13, the control circuit 14c and the drive circuit 14d for controlling and driving the actuator 14, the control circuit 15c and the drive circuit 15d for controlling and driving the actuator 15, and the control circuit 16c and the drive circuit 16d for controlling and driving the actuator 16 are placed in the housing constituting the arms of the robot 1.

Circuits with the identical circuit configuration and a common electrical specification for each component may be used as the control circuits 11c to 16c. Circuits with similar circuit configurations may be used as the drive circuits 11d to 16d; however, since output electric power varies with a varying load drive capability of a motor for each actuator, devices with different electrical specifications are used in the drive circuits 11d to 16d as power semiconductor devices etc. to be mounted. The control circuit 11c executes servo control of the motor 11m, and the drive circuit 11d operates in accordance with a control signal from the control circuit 11c and outputs an electric power signal driving the motor 11m. The control circuits 12c to 16c also have functions similar to those of the control circuit 11c, and the drive circuits 12d to 16d also have functions similar to those of the drive circuit 11d.

An operation control unit 51 in the robot controller 50 is configured to generate a trajectory plan in accordance with an operation program, determines the position of each axis by kinematic calculation, and transmits a command to the actuator for the axis. Each of the control circuits 11c to 16c for the actuators 11 to 16 executes servo control on the motor in accordance with a command from the operation control unit 51, and the drive circuits 11d to 16d output electric power signals for driving the motors in accordance with control signals from the control circuits 11c to 16c, respectively.

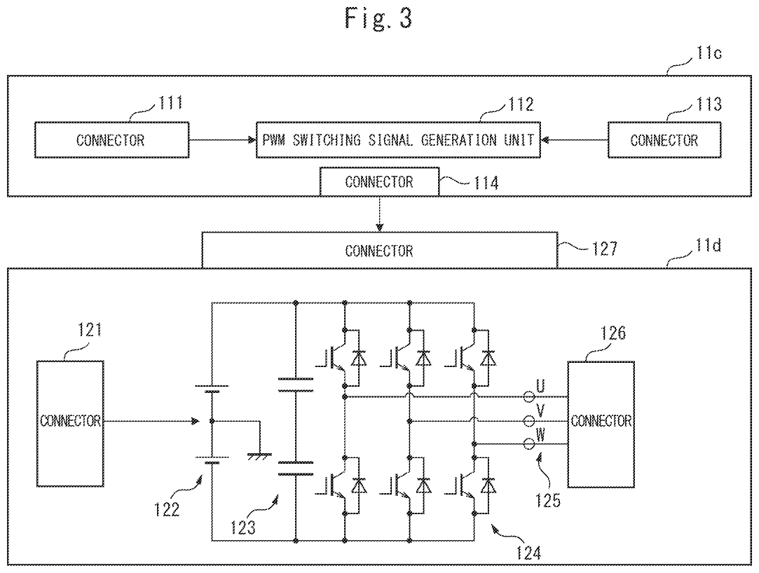

FIG. 3 is a diagram illustrating a configuration example of circuits in a motor driver (i.e., circuits for driving a motor) including a control circuit and a drive circuit. While a circuit configuration of the control circuit 11c and the drive circuit 11d are representatively illustrated, the control circuits 12c to 16c also have circuit configurations similar to those of the control circuit 11c, and the drive circuits 12d to 16d also have circuit configurations similar to those of the drive circuit 11d.

As illustrated in FIG. 3, the control circuit 11c includes a connector 111 for receiving a command signal from the operation control unit 51 in the robot controller 50, a connector 113 for receiving a position feedback signal etc. from the encoder 11e, and a connector 114 for supplying a control signal to the drive circuit 11d. The control circuit 11c further includes a PWM switching signal generation unit 112 configured to generate a PWM switching signal in accordance with a command from the operation control unit 51 and various feedback signals such as the position feedback signal. The PWM switching signal generation unit 112 may be configured with, for example, a microcontroller unit (MCU) or a dedicated custom LSI. With the configuration, the control circuit 11c executes servo control of the motor 11m in accordance with a command (such as a position command) from the operation control unit 51.

The drive circuit 11d includes a connector 121 for receiving external power supply, a connector 127 for receiving a control signal from the control circuit 11c, and a connector 126 for outputting an alternating-current power signal for driving the motor 11m. The drive circuit 11d further includes a power supply unit 122 including a smoothing capacitor 123, and an inverter unit 124 configured to generate electric power signals 125 in a U-phase, a V-phase, and a W-phase in accordance with a PWM switching signal from the control circuit 11c. The power supply unit 122 is a part serving to supply direct-current power and therefore is indicated by using a symbol of a direct-current power supply in the diagram. In the configuration, the electric power signals 125 in the U-phase, the V-phase, and the W-phase are output through the connector 126. A switching element constituting the inverter unit 124 is configured with a power semiconductor device such as a MOSFET, an insulated gate bipolar transistor (IGBT), or an intelligent power module (IPM).

In an industrial articulated robot and particularly in a six-axis articulated robot, the J2 arm 22 and the J3 arm 23 among the entire arms are generally formed relatively long due to the nature of being main parts serving as a human arm in regard to movements of the robot and securing the size of a movable range of the robot. Accordingly, the J2 arm 22 and the J3 arm 23 among the entire arms may secure a relatively large internal space for placing components. On the other hand, the J1 arm 21 is formed with a large diameter and a short length due to the nature of being a part supporting the entire robot 1, and the J4 arm 24 and J5 arm 25 are generally formed shorter than the J2 arm 22 and the J3 arm 23 due to being arms close to the wrist. The J6 arm 26 constitutes the wrist and therefore is formed short.

In view of such a structural characteristic of the six-axis articulated robot, a motor driver for driving actuators (motors) for three axes or more is configured to be placed in the J2 arm 22 or the J3 arm 23, according to the present embodiment. Consequently, a large area can be secured for one or more printed circuit boards constituting the motor driver.

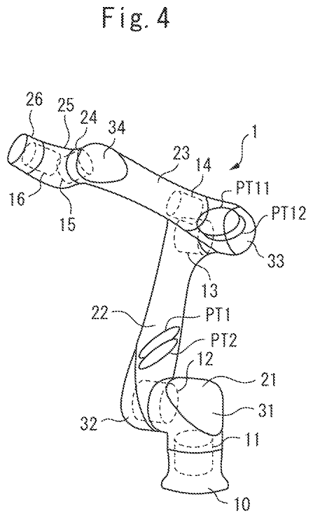

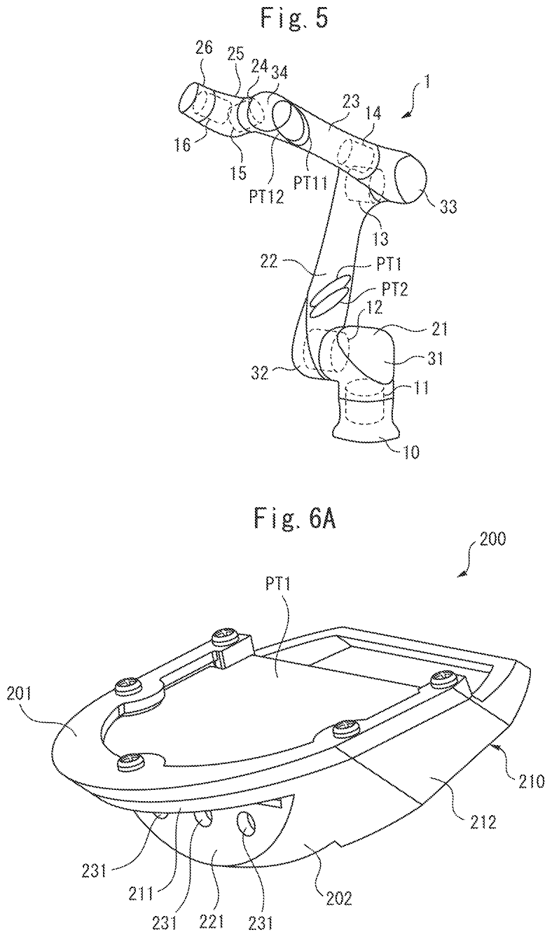

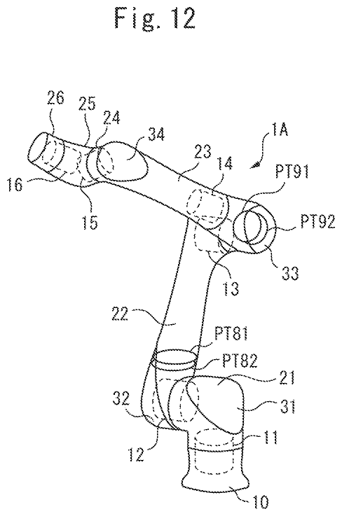

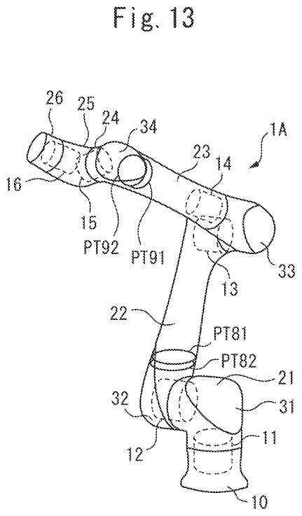

Four specific configuration examples of the robot 1 (a first example to a fourth example) will be described below. The first example (FIG. 4) and the third example (FIG. 12) relate to a motor driver including one or more printed circuit boards provided with circuits for driving three or more motors out of the six motors and being placed in one of two locations in the housing constituting the robot 1, the locations being the inside of a first extending part between a motor (the actuator 12) driving a second axis and a motor (the actuator 13) driving a third axis, and the inside of a second extending part between a motor (the actuator 13) driving the third axis and a motor (the actuator 14) driving a fourth axis viewed from the base side of the six-axis articulated robot. The second example (FIG. 5) and the fourth example (FIG. 13) relate to a motor driver including one or more printed circuit boards provided with circuits for driving three or more motors out of the six motors and being placed in one of two locations in the housing constituting the robot 1, the locations being the inside of a first extending part between the motor (the actuator 12) driving the second axis and the motor (the actuator 13) driving the third axis, and the inside of a second extending part between the motor (the actuator 14) driving the fourth axis and a motor (the actuator 15) driving a fifth axis viewed from the base side of the six-axis articulated robot.

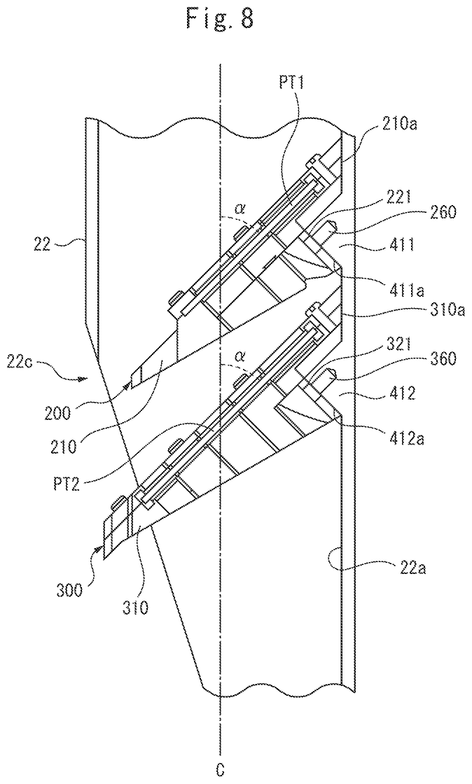

In the first example (FIG. 4) and the second example (FIG. 5), a printed circuit board constituting a motor driver is placed in an extending part of the housing of the robot 1 between a motor driving one joint axis out of a plurality of joint axes and a motor driving a joint axis next to the aforementioned one joint axis viewed from the base of the robot 1 in such as way that the surface of the printed circuit board is inclined relative to the extending direction of the extending part. In other words, the printed circuit board is placed in the extending part in a state of an angle between the surface of the printed circuit board and the extending direction of the extending part (an angle α in FIG. 8) being greater than 0 degrees and less than 90 degrees. The extending direction may also be referred to as the central axis direction of the cylindrically formed housing of the robot 1. With the configuration, the area of the printed circuit board can be increased compared with an example of a printed circuit board constituting a motor driver being substantially circular and being placed perpendicular to the axial direction in such a way as to face the actuator as described above.

FIG. 4 is a perspective view illustrating a configuration of the robot 1 according to the first example. FIG. 4 also illustrates arrangement of printed circuit boards constituting a motor driver inside arms. As illustrated in FIG. 4, two printed circuit boards PT1 and PT2 as a motor driver are placed in the J2 arm 22 rotated and driven by the actuator 12, and two printed circuit boards PT11 and PT12 as a motor driver are placed in the J3 arm 23 driven by the actuator 13. The printed circuit boards PT11 and PT12 are placed in the J3 arm 23 between the actuator 13 for driving the J3 axis and the actuator 14 for driving the J4 axis.

The printed circuit boards PT1 and PT2 control and drive the actuators 11 to 13, and the printed circuit boards PT11 and PT12 control and drive the actuators 14 to 16. More specifically, the printed circuit board PT1 placed in the J2 arm 22 is provided with the control circuits 11c, 12c, and 13c for controlling the actuators 11 to 13 (see FIG. 2). The printed circuit board PT2 is provided with the drive circuits 11d, 12d, and 13d supplying electric power signals to the actuators 11 to 13.

The printed circuit board PT11 placed in the J3 arm 23 is provided with the control circuits 14c, 15c, and 16c for controlling the actuators 14 to 16. The printed circuit board PT12 is provided with the drive circuits 14d, 15d, and 16d supplying electric power signals to the actuators 14 to 16 (see FIG. 2). Cables for supplying power and control signals to the printed circuit boards PT1, PT2, PT11, and PT12 from the robot controller 50 side, cables between the printed circuit boards PT1 and PT2 and the actuators 11 to 13, cables between the printed circuit boards PT11 and PT12 and the actuators 14 to 16, etc. are internally attached to the housing constituting the arms of the robot 1.

Covers 31, 32, 33, and 34 are provided on the housing of the robot 1, and the covers are fixed to the housing by fixing members (unillustrated) such as screws.

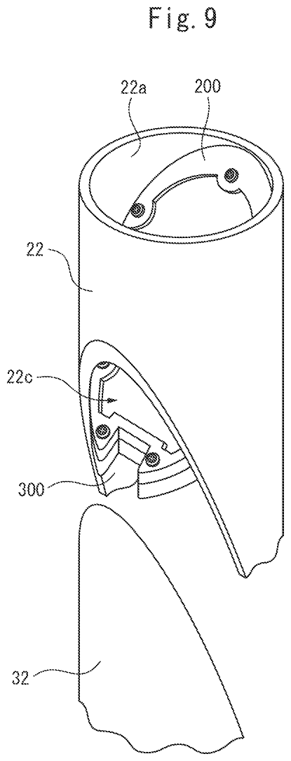

The cover 32 is formed in a shape acquired by cutting a part of an end of the J2 arm 22 on the base end side close to one side in the lateral direction in the diagram by a cutting plane inclined relative to the central axis direction of the J2 arm 22. In other words, the cover 32 is separably formed in such a way that a portion including an end and side faces on one end side of the J2 arm 22 is cut by a cutting plane inclined relative to the extending direction of the J2 arm 22. By removing the cover 32 from the body of the J2 arm 22, the printed circuit boards PT1 and PT2 can be easily put in and taken out, through an opening 22c in the body of the J2 arm 22, along a direction in which the printed circuit boards PT1 and PT2 are fixed inside the body of the J2 arm 22 (see FIG. 8 and FIG. 9). By forming the cover 32 as described above, the size of the cover 32 as a separating body can be reduced to a minimum, which enables a configuration in which reduction in strength of the J2 arm 22 as a whole due to a structure allowing separation between the cover 32 and the body of the J2 arm 22 can be suppressed.

The cover 33 of the J3 arm 23 is formed in a shape acquired by cutting a part of an end of the J3 arm 23 on the base end side close to the front side in the diagram by a cutting plane inclined relative to the central axis direction of the J3 arm 23. In other words, the cover 33 is separably formed in such a way that a portion including an end and side faces on one end side of the J3 arm 23 is cut by a cutting plane inclined relative to the extending direction of the J3 arm 23. By removing the cover 33 from the body of the J3 arm 23, the printed circuit boards PT11 and PT12 can be easily put in and taken out, through an opening in the body of the J3 arm 23, along a direction in which the printed circuit boards PT11 and PT12 are fixed inside the body of the J3 arm 23. By forming the cover 33 as described above, the size of the cover 33 as a separating body can be reduced to a minimum, which enables a configuration in which reduction in strength of the J3 arm 23 as a whole due to a structure allowing separation between the cover 33 and the body of the J3 arm 23 can be suppressed.

FIG. 5 is a diagram illustrating a configuration example of the robot 1 according to the second example. In the second example, the printed circuit boards PT11 and PT12 are placed at positions different from those in the first example. Specifically, as illustrated in FIG. 5, the printed circuit boards PT11 and PT12 are placed at positions close to the tip side in the internal space of the J3 arm 23. In other words, the printed circuit boards PT11 and PT12 are placed between the actuator 14 for driving the fourth axis and the actuator 15 for driving the fifth axis in the J3 arm 23.

While the actuator 14 for rotating and driving the J4 arm 24 is placed in the J3 arm, the actuator 14 may generally be placed at a position close to the base end in the J3 arm 23 as is the case in the present embodiment (FIG. 4 and FIG. 5) from the viewpoint of reducing the moment of inertia on the arm tip side. Accordingly, it may be said that the second example is a configuration advantageous to a case in which the space between the actuator 14 and the actuator 15 in the J3 arm 23 is relatively large.

The cover 34 of the J3 arm 23 is formed in a shape acquired by cutting a part of an end of the J3 arm 23 on the tip side close to the front side in the diagram by a cutting plane inclined relative to the central axis direction of the J3 arm 23. In other words, the cover 34 is separably formed in such a way that a portion including an end and side faces on one end side of the J3 arm 23 is cut by a cutting plane inclined relative to the extending direction of the J3 arm 23. By removing the cover 34 from the body of the J3 arm 23, the printed circuit boards PT11 and PT12 can be easily put in and taken out, through the opening in the body of the J3 arm 23, along a direction in which the printed circuit boards PT11 and PT12 are fixed inside the body of the J3 arm 23. By forming the cover 34 as described above, the size of the cover 34 as a separating body can be reduced to a minimum, which enables a configuration in which reduction in strength of the J3 arm 23 as a whole due to a structure allowing separation between the cover 34 and the body of the J3 arm 23 can be suppressed.

Configurations of a motor driver 200 including the printed circuit board PT1 and a motor driver 300 including the printed circuit board PT2, and a mounting structure of the motor drivers 200 and 300 into the J2 arm 22 will be described below. A motor driver including the printed circuit board PT11 may have a configuration similar to that of the motor driver 200. Further, a motor driver including the printed circuit board PT12 may have a configuration similar to that of the motor driver 300. Therefore, arrangement and a mounting structure of the motor driver including the printed circuit board PT11 and the motor driver including the printed circuit board PT12 into the J3 arm 23 may be configured similarly to the arrangement and the mounting structure of the motor drivers 200 and 300 into the J2 arm 22. A configuration in which the motor driver 200 and the motor driver 300 are integrated may be collectively referred to as a motor driver. The motor drivers 200 and 300 and the mounting structure thereof into the J2 arm 22 will be described below.

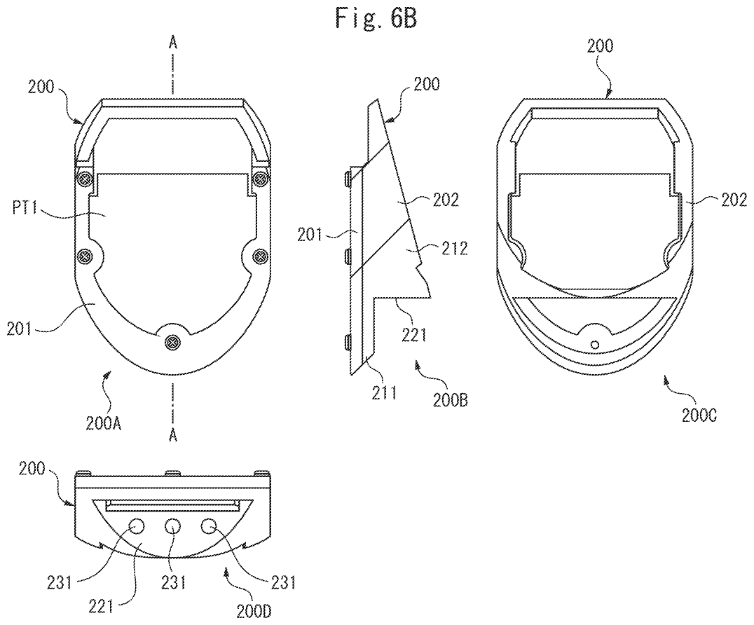

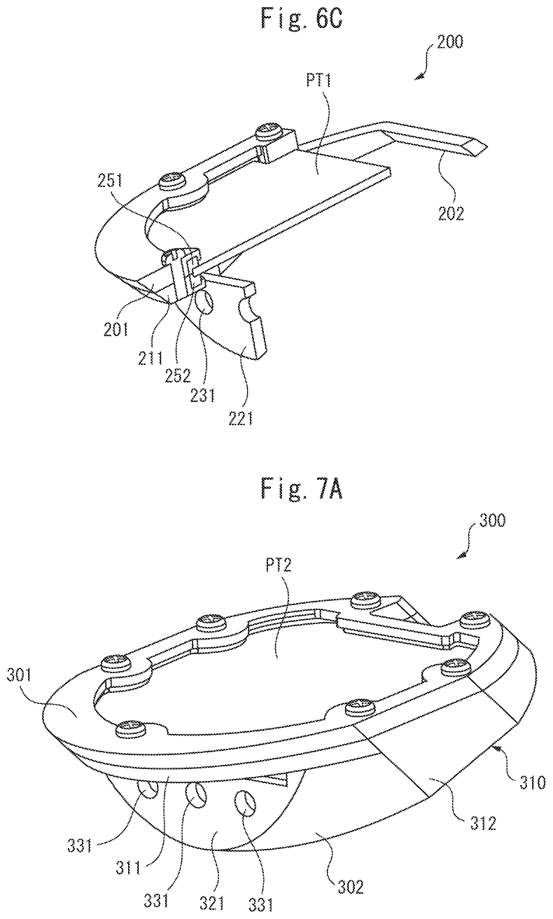

FIG. 6A illustrates a perspective view of a configuration example of the motor driver 200 including the printed circuit board PT1 provided with the control circuits 11c to 13c. FIG. 6B illustrates a top view (sign: 200A), a side view (sign: 200B), a bottom view (sign: 200C), and a front view (sign: 200D) of the motor driver 200. FIG. 6C illustrates a cross-sectional perspective view of the motor driver 200 along a line A-A illustrated in FIG. 6B.

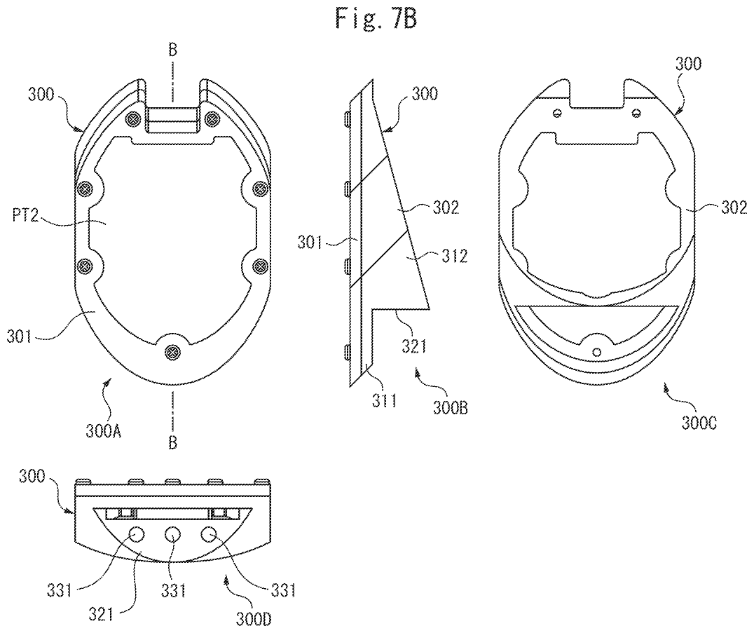

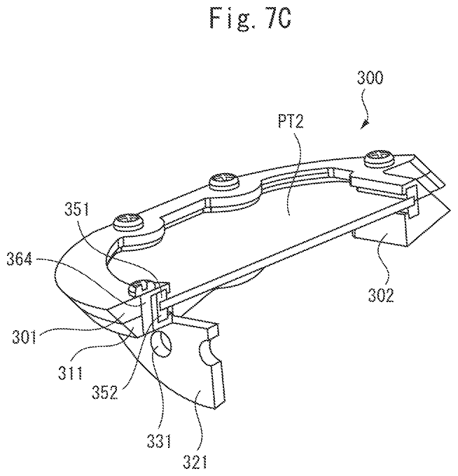

FIG. 7A illustrates a perspective view of a configuration example of the motor driver 300 including the printed circuit board PT2 provided with the drive circuits 11d to 13d. FIG. 7B illustrates a top view (sign: 300A), a side view (sign: 300B), a bottom view (sign: 300C), and a front view (sign: 300D) of the motor driver 300. FIG. 7C illustrates a cross-sectional perspective view of the motor driver 300 along a line B-B illustrated in FIG. 7B.

FIG. 8 illustrates a state of the motor drivers 200 and 300 being fixed to the internal space of the J2 arm 22 as a cross-sectional view. FIG. 8 illustrates a state of the cover 32 being removed. FIG. 8 illustrates that each of the printed circuit board PT1 constituting the motor driver 200 and the printed circuit board PT2 constituting the motor driver 300 is placed in such a way as to be inclined relative to the direction of the central axis C of the J2 arm 22 by an angle α. FIG. 9 illustrates a perspective view of a state of the motor drivers 200 and 300 being fixed to the internal space of the J2 arm 22. FIG. 9 illustrates a state in which the cover 32 is separated from the J2 arm 22 and the internal space can be viewed by cutting part of the J2 arm 22.

As illustrated in FIG. 6A, the motor driver 200 is configured with the printed circuit board PT1 provided with the control circuits 11c to 13c, and a mounting component 210. For convenience of description, a side of a mounting surface 221 (the lower left side in the diagram) may be hereinafter referred to as a front side, and the opposite side may be referred to as a rear side. The mounting component 210 is formed of a first mounting member 201 and a second mounting member 202. The printed circuit board PT1 is clamped and held by the first mounting member 201 and the second mounting member 202. The first mounting member 201 has a flat U-shape. The second mounting member 202 includes a mounting edge 211 screwed into the first mounting member 201 and a side wall part 212 constituting side walls. The side wall part 212 forms an even wall surface (the mounting surface 221) on the front side and forms two side walls from the front side toward the rear side; and the two sides are connected on the rear side and constitute a grip part. The side wall part 212 is formed such that the side wall part 212 extends from the front side toward the rear side along the circumference of the second mounting member 202 and the height thereof viewed from the mounting edge 211 decreases from the front side toward the rear side (see the side view (sign: 200B) in FIG. 6B).

The first mounting member 201 and the second mounting member 202 are connected to each other by five screws in this example. As illustrated in the front view (sign: 200D) in FIG. 6B, three screw holes 231 for screwing the mounting surface 221 into a mounting part formed on the inner wall of the J2 arm 22 are formed in the mounting surface 221.

FIG. 6C is a cross-sectional perspective view of the motor driver 200 along the line A-A illustrated in FIG. 6B. As illustrated in FIG. 6C, the printed circuit board PT1 is held in such a way that the circumferential part of the board is clamped by the first mounting member 201 and the mounting edge 211 of the second mounting member 202. Further, as illustrated in a section in the front part in FIG. 6C, vibration-absorbing materials 251 and 252 are placed between the circumferential part of the printed circuit board PT1 and the first mounting member 201 and between the circumferential part of the printed circuit board PT1 and the mounting edge 211 of the second mounting member 202, respectively; and the printed circuit board PT1 is firmly screwed between the first mounting member 201 and the mounting edge 211 in a state of being placed between the upper and lower vibration-absorbing materials 251 and 252. Consequently, propagation of vibration from the robot 1 side to the printed circuit board PT1 can be prevented. Various elastic members (such as a rubber vibration isolator and a gel member) may be used as the vibration-absorbing materials 251 and 252. Such an antivibration measure can improve reliability as a motor driver.

As illustrated in FIG. 7A, the motor driver 300 is configured with the printed circuit board PT2 provided with the drive circuits 11d to 13d, and a mounting component 310. For convenience of description, a side of a mounting surface 321 (the lower left side in the diagram) may be hereinafter referred to as a front side, and the opposite side may be referred to as a rear side. The mounting component 310 is formed of a first mounting member 301 and a second mounting member 302. The printed circuit board PT2 is clamped and held by the first mounting member 301 and the second mounting member 302. The first mounting member 301 has a flat and elliptic shape. The second mounting member 302 includes a mounting edge 311 screwed into the first mounting member 301 and a side wall part 312 constituting side walls. The side wall part 312 forms an even wall surface (the mounting surface 321) on the front side and forms two side walls of the second mounting member 302 from the front side toward the rear side; and the two side walls are connected on the rear side. The side wall part 312 is formed such that the side wall part 312 extends toward the rear side along the circumference of the second mounting member 302 and the height thereof viewed from the mounting edge 311 decreases from the front side toward the rear side (see the side view (sign: 300B) in FIG. 7B).

The first mounting member 301 and the second mounting member 302 are connected to each other by seven screws in this example. As illustrated in the front view (sign: 300D) in FIG. 7B, three screw holes 331 for screwing the mounting surface 321 into a mounting part formed on the inner wall of the J2 arm 22 is formed in the mounting surface 321.

FIG. 7C is a cross-sectional perspective view of the motor driver 300 along the line B-B illustrated in FIG. 7B. As illustrated in FIG. 7C, the printed circuit board PT2 is held in such a way that the circumferential part of the board is clamped by the first mounting member 301 and the mounting edge 311 of the second mounting member 302. Further, as illustrated in a section in the front part in FIG. 7C, vibration-absorbing materials 351 and 352 are placed between the circumferential part of the printed circuit board PT2 and the first mounting member 301 and between the circumferential part of the printed circuit board PT2 and the mounting edge 311 of the second mounting member 302, respectively; and the printed circuit board PT2 is firmly fixed between the first mounting member 301 and the mounting edge 311 by a screw 364 in a state of being placed between the upper and lower vibration-absorbing materials 351 and 352. Consequently, propagation of vibration from the robot side to the printed circuit board PT2 can be prevented. A material similar to the vibration-absorbing materials 251 and 252 may be used as the vibration-absorbing materials 351 and 352.

As illustrated in FIG. 8, a first protrusion part 411 and a second protrusion part 412 for mounting the motor drivers 200 and 300 are formed on an inner wall surface 22a of the J2 arm 22 in such a way as to protrude to the internal space side, each part having a triangular section. For example, the inner wall surface 22a is formed of metal. As illustrated, the motor driver 200 may be mounted on the first protrusion part 411, and the motor driver 300 may be mounted on the second protrusion part 412. Screw holes are formed in a lower inclined surface 411a of the first protrusion part 411 at positions matching the three screw holes 231 formed in the mounting surface 221 of the motor driver 200. Screw holes are formed in a lower inclined surface 412a of the second protrusion part 412 at positions matching the three screw holes 331 formed in the mounting surface 321 at the front of the motor driver 300. The opening 22c formed in the J2 arm 22 by separating the cover 32 is located on a opposite side with respect to a side of the inner wall surface 22a on which the first protrusion part 411 and the second protrusion part 412 are located.

In the aforementioned configuration, the motor driver 200 is screwed into the first protrusion part 411 in a state where the mounting surface 221 at the front of the motor driver 200 is pushed against the lower inclined surface 411a of the first protrusion part 411 and screws 260 and a tool (unillustrated) are entered into the internal space of the J2 arm 22 from the opening 22c side. The inclination angle of an end surface 210a of the mounting component 210 on the front side in the motor driver 200 is determined in such a way that the end surface 210a comes in close contact with the inner wall surface 22a of the J2 arm 22 in a state of the mounting surface 221 being pushed against the lower inclined surface 411a. Consequently, the motor driver 200 is firmly fixed in the internal space of the J2 arm 22 as illustrated.

In the aforementioned configuration, the motor driver 300 is screwed into the second protrusion part 412 in a state where the mounting surface 321 at the front of the motor driver 300 is pushed against the lower inclined surface 412a of the second protrusion part 412 and screws 360 and a tool (unillustrated) are entered into the internal space of the J2 arm 22 from the opening 22c side. The inclination angle of an end surface 310a of the mounting component 310 on the front side in the motor driver 300 is determined in such a way that the end surface 310a comes in close contact with the inner wall surface 22a of the J2 arm 22 in a state of the mounting surface 321 being pushed against the lower inclined surface 412a. Consequently, the motor driver 300 is firmly fixed in the internal space of the J2 arm 22 as illustrated.

Thus, each of the motor drivers 200 and 300 can be moved in the J2 arm 22, while maintaining a posture at the time when each of them is entered through the opening 22c into the J2 arm 22, along a direction of entry from the opening 22c toward the internal space of the J2 arm 22, and can be fixed by being pushed against the inner wall surface 22a. Accordingly, each of the motor drivers 200 and 300 can be easily fixed to the space in the J2 arm 22.

As described above, FIG. 9 illustrates a state of the motor drivers 200 and 300 being mounted to the internal space of the J2 arm 22 as a perspective view acquired by cutting part of the J2 arm 22. FIG. 9 illustrates a state of the cover 32 being separated, and it may be understood that the internal space of the J2 arm 22 can be accessed in this state.

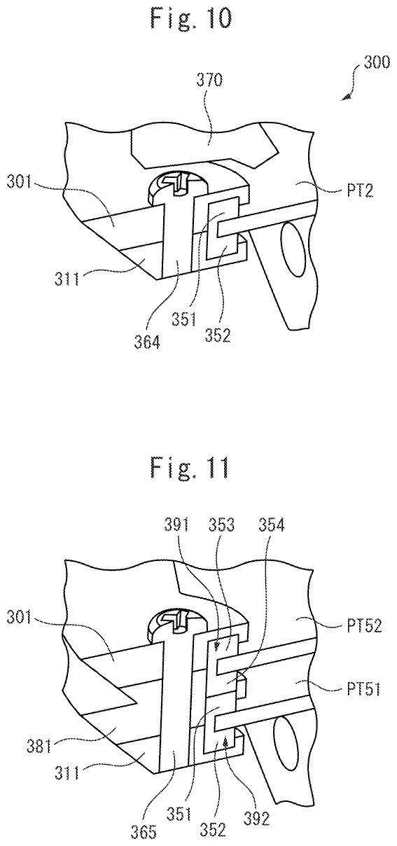

Since a circuit element on a printed circuit board may become a heating element, the motor driver 200 or 300 may include a configuration for heat dissipation. An example of applying a configuration for heat dissipation to the motor driver 300 will be described with reference to FIG. 10. FIG. 10 is a diagram illustrating an area around the front end of the sectional part in the cross-sectional perspective view illustrated in FIG. 7C (an area around the end on the front side in FIG. 7C). A configuration example improving a heat dissipation characteristic by dissipating heat generated on the printed circuit board PT2 to the mounting component 310 side through a heat transfer component 370 is illustrated. It is assumed that the mounting component 310 is formed of metal.

In FIG. 10, the heat transfer component 370 functions to conduct heat generated on the printed circuit board PT2 to the first mounting member 301 by connecting the printed circuit board PT2 to the first mounting member 301. An end of the heat transfer component 370 on the printed circuit board PT2 side may be placed in such a way as to be in close contact with a heating component (a power semiconductor device). Various members such as a thin metal plate and a film heat transfer material may be used as the heat transfer component 370. Such arrangement of a heat transfer component formed of a particularly flexible material enables an increased rated current as a motor driver without hindering the antivibration measure as described above.

While each of the motor drivers 200 and 300 is provided with one printed circuit board in the aforementioned examples, each motor driver may be provided with a plurality of printed circuit boards. An example of a configuration of a motor driver designed such that two printed circuit boards are mounted based on the configuration of the motor driver 300 will be described with reference to FIG. 11. FIG. 11 is a diagram illustrating a part corresponding to an area around the front end of the sectional part in the cross-sectional perspective view of the motor driver 300 illustrated in FIG. 7C (the area around the end on the front side in FIG. 7C).

In this example, a holding member 381 is placed between the first mounting member 301 and the mounting edge 311. The holding member 381 may be formed as a flat member having substantially the same shape as that of the first mounting member 301. Consequently, a printed circuit board PT52 can be clamped and held by vibration-absorbing materials 353 and 354 in a grooved space 391 formed between the internal circumferential part of the first mounting member 301 and the internal circumferential part of the holding member 381, and a printed circuit board PT51 can be clamped and held by the vibration-absorbing materials 351 and 352 in a grooved space 392 formed between the internal circumferential part of the mounting edge 311 and the internal circumferential part of the holding member 381. The first mounting member 301, the holding member 381, and the mounting edge 311 are collectively fixed by a screw 365. Consequently, a configuration in which the two printed circuit boards PT51 and PT52 are mounted on a motor driver can be provided.

FIG. 12 is a diagram illustrating a configuration of a robot 1A according to the third example. In the robot 1A according to the third example, each of printed circuit boards PT81 and PT82 constituting a motor driver placed in the J2 arm 22 is not placed in such a way as to be inclined relative to the central axis direction of the J2 arm 22 as is the case with the first example and is formed in a circular shape oriented substantially perpendicular to the central axis direction. Further, each of printed circuit boards PT91 and PT92 constituting a motor driver placed in the J3 arm 23 is not placed in such a way as to be inclined relative to the central axis direction of the J3 arm 23 as is the case with the first example either and is formed in a circular shape oriented substantially perpendicular to the central axis direction. It is assumed that the configuration in other respects is similar to the configuration described in the first example.

The printed circuit board PT81 is provided with control circuits identical to those on the printed circuit board PT1 in the first example (the control circuits 11c, 12c, and 13c). The printed circuit board PT82 is provided with drive circuits identical to those on the printed circuit board PT2 in the first example (the drive circuits 11d, 12d, and 13d). The printed circuit board 91 is provided with control circuits identical to those on the printed circuit board PT11 in the first example (the control circuits 13c, 14c, and 15c). The printed circuit board PT92 is provided with drive circuits identical to those on the printed circuit board PT2 in the first example (the drive circuits 14d, 15d, and 16d).

Each of the printed circuit boards PT81, PT82, PT91, and PT92 may be configured to be fixed to an arm inner wall with a mounting component in between, the mounting component being formed to clamp and hold the circumferential part of the board from the top surface side and the bottom surface side, similarly to the aforementioned motor driver 200 or 300.

FIG. 13 is a diagram illustrating a configuration of the robot 1A according to the fourth example. In the robot 1A according to the fourth example, each of the printed circuit boards PT81 and PT82 constituting a motor driver placed in the J2 arm 22 is not placed in such a way as to be inclined relative to the central axis direction of the J2 arm 22 as is the case with the second example and is formed in a circular shape oriented substantially perpendicular to the central axis direction. Further, each of the printed circuit boards PT91 and PT92 constituting a motor driver placed in the J3 arm 23 is not placed in such a way as to be inclined relative to the central axis direction of the J3 arm 23 as is the case with the second example either and is formed in a circular shape oriented substantially perpendicular to the central axis direction. It is assumed that the configuration in other respects is similar to the configuration described in the second example.

The printed circuit board PT81 is provided with control circuits identical to those on the printed circuit board PT1 in the second example (the control circuits 11c, 12c, and 13c). The printed circuit board PT82 is provided with drive circuits identical to those on the printed circuit board PT2 in the second example (the drive circuits 11d, 12d, and 13d). The printed circuit board 91 is provided with control circuits identical to those on the printed circuit board PT11 in the second example (the control circuits 13c, 14c, and 15c). The printed circuit board PT92 is provided with drive circuits identical to those on the printed circuit board PT2 in the second example (the drive circuits 14d, 15d, and 16d).

Each of the printed circuit boards PT81, PT82, PT91, and PT92 may be configured to be fixed to an arm inner wall with a mounting component in between, the mounting component being formed to clamp and hold the circumferential part of the board from the top surface side and the bottom surface side, similarly to the aforementioned motor driver 200 or 300.

Since a motor driver can be placed in the J2 arm 22 or the J3 arm 23 including large space in the configurations described above as the third example and the fourth example as well, the area secured for a printed circuit board constituting the motor driver can be increased.

In each of the examples of the robot illustrated in FIG. 4, FIG. 5, FIG. 12, and FIG. 13, one printed circuit board P1 (the printed circuit board PT81) is configured to be provided with the control circuits 11c to 13c for the actuators 11 to 13 for three axes in the J2 arm 22, and one printed circuit board PT2 (the printed circuit board PT82) is configured to be provided with the drive circuits 11d to 13d for the actuators 11 to 13 for three axes. Similarly, with regard to a motor driver provided in the J3 arm 23, one printed circuit board PT11 (the printed circuit board 91) is configured to be provided with the control circuits 14c to 16c for the actuators 14 to 16 for three axes, and one circuit board PT12 (the printed circuit board PT92) is configured to be provided with the drive circuits 14d to 16d for the actuators 14 to 16 for three axes.

In such a configuration, the printed circuit board PT1 (the printed circuit board PT81) provided with the control circuits 11c to 13c and the printed circuit board PT11 (the printed circuit board 91) provided with the control circuits 14c to 16c may be identically designed regarding various design specifications including electrical characteristics of components. Further, according to the aforementioned configuration, a motor control circuit (a circuit board) for driving and controlling actuators for three axes may have a dual-board configuration. The configuration is useful for saving the area of a board for a motor driver. Further, the configuration in which a motor driver is placed in the J2 arm 22 or the J3 arm 23 enables the motor driver to be placed at a location separated from an actuator, reduces heat conduction from the actuator to the motor driver, and contributes to an improved rated current of the motor driver.

The aforementioned example of providing a drive circuit for three axes by a dual-printed-circuit-board configuration in each of the J2 arm 22 and the J3 arm 23 is an example, and modified examples as follows may also be configured. (1) The number of printed circuit boards provided in the J2 arm 22 or the J3 arm 23 may be three. In this case, a control circuit and a drive circuit for one axis are configured to be provided on one printed circuit board, and three printed circuit boards for three axes may be configured to be placed in the J2 arm 22 or the J3 arm. (2) In a configuration in which a large board area per board can be secured by placing a printed circuit board in an inclined manner as is the case with the first and second examples in particular, the number of printed circuit boards placed in the J2 arm 22 or the J3 arm may be one. In this case, a control circuit and a drive circuit for three axes are configured to be provided on one printed circuit board. The configuration according to the present embodiment improves a degree of freedom in design in terms of the number of printed circuit boards, the type of circuit placed on a printed circuit board in a shared manner, etc.

As described above, the present embodiment enables securement of a large area for a printed circuit board provided with a circuit for driving a motor for a joint axis in a six-axis articulated robot.

While the present invention has been described above by using the typical embodiments, it may be understood by a person skilled in the art that changes, and various other changes, omissions, and additions can be made to the aforementioned embodiments without departing from the scope of the present invention.

The configurations of the motor drivers 200 and 300 according to the aforementioned embodiment are examples, and the motor driver may have various configurations in which, in an extending part of the housing of the robot between an actuator (motor) and another actuator (motor) in the robot 1, a printed circuit board is placed in such a way as to be inclined relative to the central axis direction of the extending part.

The robot controller 50 may be configured as a common computer including a CPU, a ROM, a RAM, a storage device, an operation unit, a display unit, an input-output interface, a network interface, etc. The teach pendant 60 may be configured as a common computer including a CPU, a ROM, a RAM, a storage device, an operation unit, a display unit, an input-output interface, a network interface, etc.

### Reference Signs List

1, 1A Robot
10 Base
11 to 16 Actuator
11c to 16c Control circuit
11d to 16d Drive circuit
21 J1 arm
22 J2 arm
23 J3 arm
24 J4 arm
25 J5 arm
26 J6 arm
31 to 34 Cover
50 Robot controller
51 Operation control unit
60 Teach pendant
111, 113, 114 Connector
112 PWM switching signal generation unit
121, 126, 127 Connector
122 Power supply unit
123 Smoothing capacitor
124 Inverter unit
125 Electric power signal
PT1, PT2, PT11, PT12 Printed circuit board
200 Motor driver
201 First mounting member
202 Second mounting member
221 Mounting surface
210 Mounting component
251, 252 Vibration-absorbing material
300 Motor driver
301 First mounting member
302 Second mounting member
321 Mounting surface
310 Mounting component
351, 352 Vibration-absorbing material
364 Screw
411 First protrusion part
411a Lower inclined surface
412 Second protrusion part
412a Lower inclined surface

PT81, PT82, PT91, PT92 Printed circuit board

1. A six-axis articulated robot comprising:
six motors for respectively driving six axes in the six-axis articulated robot; and
a motor driver including one or more printed circuit boards provided with a circuit for driving three or more motors out of the six motors, the motor driver being placed, in a housing constituting the six-axis articulated robot, in at least one of an inside of a first extending part between a motor driving a second axis and a motor driving a third axis, and an inside of a second extending part between a motor driving the third axis and a motor driving a fourth axis, viewed from a base side of the six-axis articulated robot.

2. A six-axis articulated robot comprising:
six motors for respectively driving six axes in the six-axis articulated robot; and
at least one motor driver including one or more printed circuit boards provided with a circuit for driving three or more motors out of the six motors, the at least one motor driver being placed, in a housing constituting the six-axis articulated robot, in at least one of an inside of a first extending part between a motor driving a second axis and a motor driving a third axis, and an inside of a second extending part between a motor driving a fourth axis and a motor driving a fifth axis, viewed from a base side of the six-axis articulated robot.

3. The six-axis articulated robot according to claim 1, wherein
the one or more printed circuit boards include a first printed circuit board provided with a control circuit for executing servo control on each of the three or more motors and a second printed circuit board provided with a drive circuit outputting an electric power signal driving each of the three or more motors in accordance with a control signal from the control circuit.

4. The six-axis articulated robot according to claim 1, wherein
a first motor driver including one or more printed circuit boards provided with a circuit for driving first to third motors out of the six motors is placed inside the first extending part, and
a second motor driver including one or more printed circuit boards provided with a circuit for driving fourth to sixth motors out of the six motors is placed inside the second extending part.

5. The six-axis articulated robot according to claim 4, wherein
the one or more printed circuit boards placed in the first extending part include a first printed circuit board provided with a control circuit for executing servo control on the first to third motors and a second printed circuit board provided with a drive circuit outputting an electric power signal driving each of the first to third motors in accordance with a control signal from the control circuit, and
the one or more printed circuit boards placed in the second extending part include a third printed circuit board provided with a control circuit for executing servo control on each of the fourth to sixth motors and a fourth printed circuit board provided with a drive circuit outputting an electric power signal driving each of the fourth to sixth motors in accordance with a control signal from the control circuit.

6. The six-axis articulated robot according to claim 5, wherein
the first printed circuit board and the third printed circuit board have an identical configuration.

7. The six-axis articulated robot according to claim 2, wherein
a first motor driver including one or more printed circuit boards provided with a circuit for driving first to third motors out of the six motors is placed inside the first extending part, and
a second motor driver including one or more printed circuit boards provided with a circuit for driving fourth to sixth motors out of the six motors is placed inside the second extending part.

8. The six-axis articulated robot according to claim 7, wherein
the one or more printed circuit boards placed in the first extending part include a first printed circuit board provided with a control circuit for executing servo control on the first to third motors and a second printed circuit board provided with a drive circuit outputting an electric power signal driving each of the first to third motors in accordance with a control signal from the control circuit, and
the one or more printed circuit boards placed in the second extending part include a third printed circuit board provided with a control circuit for executing servo control on each of the fourth to sixth motors and a fourth printed circuit board provided with a drive circuit outputting an electric power signal driving each of the fourth to sixth motors in accordance with a control signal from the control circuit.

9. The six-axis articulated robot according to claim 8, wherein
the first printed circuit board and the third printed circuit board have an identical configuration.
